(19) United States
(12) Patent Application Publication
(10) Pub. No.: US 2007/0117121 A1
(43) Pub. Date: May 24, 2007

(54) cDNA library preparation

(76) Inventors: Stephen Kyle Hutchison, Branford, CT (US); Jan Fredrik Simons, Branford, CT (US); David Auden Willoughby, Jupiter, FL (US)

Correspondence Address: MINTZ LEVIN COHN FERRIS GLOVSKY & POPEO, 666 THIRD AVENUE, NEW YORK, NY, 10017, US

(21) Appl. No.: 11/523,120

(22) Filed: Sep. 18, 2006

Related U.S. Application Data
(60) Provisional application No. 60/717,922, filed on Sep. 16, 2005.

(51) Int. Cl. C40B 30/06; C40B 40/08

(52) U.S. Cl. 435/6

(57) ABSTRACT

New biochemical protocols for high throughput processing of mRNA samples into cDNA libraries with adaptor sequences compatible with automated sequencing systems are provided. The provided methods produces cDNA libraries which do not have 3′ bias associated with current cDNA library production methods. New methods for the production of DNA libraries from DNA are also provided.

### CROSS-REFERENCE TO RELATED APPLICATIONS

This application claims priority from U.S. Provisional Application Ser. No. 60/717,922, filed on Sep. 16, 2005.

Each of the applications and patents cited in this text, as well as each document or reference cited in each of the applications and patents (including during the prosecution of each issued patent; “application cited documents”), and each of the U.S. and foreign applications or patents corresponding to and/or claiming priority from any of these applications and patents, and each of the documents cited or referenced in each of the application cited documents, are hereby expressly incorporated herein by reference. More generally, documents or references are cited in this text, either in a Reference List before the claims, or in the text itself; and, each of these documents or references (“herein-cited references”), as well as each document or reference cited in each of the herein-cited references (including any manufacturer's specifications, instructions, etc.), is hereby expressly incorporated herein by reference. Documents incorporated by reference into this text may be employed in the practice of the invention.

### FIELD OF THE INVENTION

The present invention relates generally to the field of molecular biology and in particular to the creation of cDNA and DNA libraries.

### BACKGROUND OF THE INVENTION

Current methods of transcript profiling by sequencing has been limited to Sanger sequencing of full-length cDNA clones and/or sequencing of small “tags” from the 5′-end or 3′-end of each mRNA. These methods of sequencing are labor intensive and their widespread adoption have been hindered by technical limitations.

Generally, methods for sequencing mRNA involve the creation of a cDNA library and the sequencing of the inserts of the cDNA library. The generation of a cDNA library in a form suitable for rapid sequencing is a long, tedious process with a number of technically difficult steps. In summary, a typical procedure for isolating mRNA from a cell requires (1) disruption of cells to release cellular contents, (2) isolation of total RNA from the cell, (3) selection of the mRNA population by running the extracted RNA through an oligo(dT) cellulose column and (4) synthesis of cDNA from RNA using an RNA-dependent DNA polymerase (reverse transcriptase) to synthesize the first strand of a cDNA, (5) synthesis of the second strand from cDNA to generate double stranded cDNA by a DNA dependent DNA polymerase such as E. coli pol I Klenow fragment, (6) cloning of double stranded cDNA into a vector, and (7) transfecting the vector into a host (e.g., bacteria). At all stages where RNA is present, great care is required to ensure that the preparation does not come into contact with active ribonuclease enzymes which can destroy the RNA. Ribonuclease (RNAse) enzymes are very stable, so even a very small amount of the active enzyme in an mRNA preparation will cause problems, such as RNA degradation. Because the goal of the cDNA cloning procedure is to obtain “full length” cDNA clones that contain the entire coding sequence of the gene, it is extremely important to use procedures that maintain the integrity of the mRNA.

The underrepresentation of the 5′ end of cDNA libraries is an inherent limitation of current techniques and is caused by a number of factors. One of the most significant factors is the random failure in the elongation process by the reverse transcriptase. As the reverse transcriptase migrate from the 3′ to 5′ end of an mRNA, a percentage of the reverse transcriptase may be disassociated from the RNA template, causing premature termination of the cDNA synthesis. Another contributing factor is the pausing, slowing, or stopping of reverse transcriptase at regions of secondary structure in the mRNA. Further, 3′ end bias is also introduced by contaminating RNase which removes the 5′ end of mRNA by degradation. The cumulative result of these factors is that the 3′ ends of mRNA are statistically more likely to be represented in current cDNA libraries than the sequences closer to the 5′ end. This 3′ bias is further enhanced for long transcripts because longer transcripts are more susceptible to each of the 3′ bias factors.

An additional disadvantage of current cDNA library production techniques involves the use of cloning vectors and host cells to amplify the library. The replication of the host vector and/or the growth of the host cells/viruses may be affected by the cDNA insert, and certain sequences would be underrepresented in a bacterial or viral cDNA library. For example, long cDNAs and cDNAs with significant repeats or secondary structure potential may be rearranged or underrepresented when the cDNA library is replicated in a host cell. Further, if cDNA encodes a lethal gene, its growth in a host cell may be compromised. Additionally, if the cDNA library is from a common host cell, like an E. coli cDNA library, the host cell RNA may contaminate the results. A method that does not use any host cells can circumvent this problem.

Commonly, for example in work involving viruses or small tissue or cell samples, the available amounts of starting DNA or RNA can be extremely limited (e.g. in the order of nanograms). The preparation of DNA or cDNA libraries from such limited amounts of starting material can be extremely difficult or even impossible by methods currently used in the art. Thus there is a need in the art for methods enabling the preparation of high quality DNA or cDNA libraries from small amounts of starting nucleic acid.

### SUMMARY OF THE INVENTION

The present invention provides a novel method for forming single stranded cDNA libraries by fragmenting a starting RNA (or population of starting RNAs), priming and synthesizing the single strand cDNA from the fragmented starting RNA, and ligating adaptor sequences to the ends of the single stranded cDNA. The resulting single stranded cDNA, comprising known adaptor sequences at the 5′ and 3′ ends, retains directional information and is suitable for automated sequencing without the need for cloning vectors or host cells in some automated sequencing system, such as the sequencing system developed by 454 Life Sciences, Branford, Conn.

One embodiment of the invention is directed to a method for generating a single stranded DNA library (e.g., cDNA library) from a starting RNA. The method involves the first step of fragmenting RNA to produce fragmented RNA. The fragmentation may be optimized to produce RNA fragments of between 100 bases to 1000 bases in size, such as between 150 to 500 bases in size. In an optional step, the RNA fragments may be size fractionated using known techniques such as gel electrophoresis or chromatography. The size fractionation may produce RNAs of between 100 to 1000 bases or between 150 to 500 bases.

Following fragmentation, the fragmented RNA is hybridized to a plurality of primers which can prime and elongate from multiple locations on the fragmented RNA. This is possible, for example, if the first primer comprises a random sequence in its hybridization region such that a population of such primers would have members that can hybridize to any sequence. The hybridized primers are elongated with reverse transcriptase to form single stranded cDNA. Following single stranded cDNA (sscDNA) synthesis, the RNA may be removed by denaturing conditions, NaOH hydrolysis, heat treatment or RNase treatment. After removal of the RNA, a first DNA adaptor may be ligated to the 5′ end of the cDNA. In a preferred embodiment, the first adaptor has a double stranded portion, as well as an overhanging (single stranded) 5′ end region which is complementary to a 5′ end of the sscDNA. Further, a second adaptor comprising an overhanging 3′ end region that is complementary to a 3′ end of the single stranded cDNA may be ligated to the 3′ end of the cDNA.

5′-first adaptor-3′5′----------cDNA--------3′5′--second adaptor--3′
||||||||||||||| |||||| |||| ||||||||||||||||||
3′-first adaptor-----------5′ 3′-------second adaptor------5′

It should be noted that the ligation of the first adaptor, at the 5′ end of the cDNA is unnecessary. The first strand cDNA synthesis primer can also be designed to incorporate a non-random 5′ portion. This nonrandom 5′ portion may have the sequence of the first adaptor (see, FIG. 2 for a sample adaptor sequence). Since any resulting cDNA would already have the desired sequence at the 5′ end, additional ligation to the first adaptor at the 5′ end is not necessary.

The first and second adaptors may be ligated to the cDNA simultaneously or in any sequential order. Further, the first adaptor, the second adaptor, or both may contain a member of a binding pair for purification. A binding pair may be any two molecules that show specific binding to each other such as FLAG/FLAG antibody; Biotin/avidin, biotin/streptavidin, receptor/ligand, antigen/antibody, receptor/ligand, polyHIS/nickel, protein A/antibody and derivatives thereof. The binding pair may be attached to either strand of the first or second adaptor. In addition, both strands of the adaptors may be each labeled with the same member of a binding pair (e.g., two biotins). The single stranded cDNA, ligated to the first and second adaptors, is then purified to form a cDNA library.

Purification of the sscDNA may be performed by size fractionation because the cDNA is longer than the adaptors or the primers. If the cDNA is attached to one member of a binding pair (e.g., biotin, described below), it can be purified by using the second member of the binding pair (e.g., streptavidin, avidin, etc) attached to a solid support.

The plurality of primers may be semi-random primers comprising one or more nonrandom primer bases of known identity. For example, the primers may be 10 bases long wherein the first base (counting from the 5′ end) and the fourth base is of a known sequence (i.e., A, G, C, T or U) and wherein the other bases (bases 2, 3, and 5-10) are of an unknown sequence. In a preferred embodiment, the first adaptor comprises a single stranded region which is complementary to the nonrandom bases of the plurality of primers (See, FIG. 1, adaptor A).

The plurality of primers may also be semi-random, with the non-random bases designed such that the primers may preferentially or specifically anneal to members of a subset of expressed sequences, such as the members of a gene family of interest. The plurality of primers may also be non-random, i.e. be sequence specific. If the primers have a specific, non-random sequence, they may bias the resulting DNA or cDNA library toward a specific expressed sequence or genome region, or to two or more members of related expressed sequence or genome regions. In any of the methods of the present invention, any random base positions (A, G, C, T, or U) in oligonucleotides may be occupied by Inosine (I), a base which is able to pair with any of the common bases A, G, C, T, or U.

One advantage of the claimed invention is that a cDNA or DNA library may be created without the use of a DNA dependent DNA polymerase (e.g., Klenow, pol I). That is, the method may be performed only using one polymerase—reverse transcriptase. Another advantage of the present invention is that the DNA or cDNA libraries may be created without a nucleic acid amplification step.

The invention also encompasses an unamplified single stranded cDNA library produced by the disclosed method. Further, the libraries of the invention may be used to produce subtraction libraries such as cDNA subtraction libraries.

If desired, the sscDNA may be made double stranded after the ligation of the adaptor by the addition of a DNA dependent DNA polymerase such as Pol I or Klenow polymerase. While this step is unnecessary in the methods of the invention, it may be used to create double stranded cDNA libraries useful for cloning or other applications.

These and other embodiments are disclosed or are obvious from and encompassed by the following Detailed Description.

### BRIEF DESCRIPTION OF THE FIGURES

The following Detailed Description, given by way of example, but not intended to limit the invention to specific embodiments described, may be understood in conjunction with the accompanying Figures, incorporated herein by reference, in which:

FIG. 1 depicts one embodiment of the directional ligation of the adaptors (A and B) onto the single stranded cDNA (sscDNA). Each adaptor consists of a longer oligonucleotide with a single-stranded part designed to anneal to the sscDNA and a shorter oligonucleotide that becomes ligated to the 3′ and 5′ ends of the sscDNA.

FIG. 2 depicts one embodiment of Tseq (transcript sequencing) library preparation.

FIG. 3 depicts one embodiment of the 5′ to 3′ distribution of sequence reads from liver cDNA libraries showing a uniform distribution of Tseq reads even for transcripts above 5,000 nucleotides in length.

FIG. 4 depicts one possible sequence of a primer. The “N” represents any base and “V” represents any base except for T (i.e., “V” represents a, g, or c).

FIG. 5 depicts annealing of 3′ adaptor to cDNA generated with the primer of FIG. 4.

FIG. 6 depicts some embodiments of Tseq adaptor structures.

FIG. 7 depicts an Agilent Bioanalyzer trace of viral RNA from influenza strain A/Puerto Rico/8/34. Numbers above peaks represent approximate size in nucleotides. The peak at 25 bp represents an internal size standard.

FIG. 8 depicts an Agilent Bioanalyzer trace of viral RNA from influenza strain A/Puerto Rico/8/34, both prior to fragmentation (blue trace), and after fragmentation (green trace). The red trace represents a standard size marker. The peaks at 25 bp represent an internal size standard.

FIG. 9 depicts an Agilent Bioanalyzer trace (red) of sscDNA obtained from viral RNA of influenza strain A/Puerto Rico/8/34, prior to ligation of the specific 3′ and 5′ adaptors. The blue trace represents a standard size marker. The peaks at 25 bp represent an internal size standard.

FIG. 10 depicts an Agilent Bioanalyzer trace of dscDNA obtained from viral RNA of influenza strain A/Puerto Rico/8/34, after 18 cycles of amplification (FIG. 10 A); and after 25 cycles of amplification (FIG. 10 B). The peaks at 25 bp represent an internal size standard.

FIG. 11 depicts plots of the depth of sequence coverage obtained across segments 1-4 of the influenza virus RNA.

FIG. 12 depicts plots of the depth of sequence coverage obtained across 3 different segments of the influenza virus RNA.

FIG. 13 depicts an Agilent Bioanalyzer trace showing the size distribution and relative nucleic acid amounts in dscDNA libraries constructed from 10, 20, 50 or 200 ng of starting influenza virus RNA, respectively. The peaks at 25 bp represent an internal size standard.

FIG. 14 depicts plots of the depth of sequence coverage obtained from 10 ng (blue ) or 200 ng (red) starting RNA. Data was plotted for both the A set (top; sequencing from 5′ to 3′) and the B set (bottom; sequencing from 3′ to 5′ of the starting RNA) respectively. This data is also represented in Table 3. The plots reveal that equivalent patterns of coverage were obtained from low input (10 ng) or higher input (200 ng) of starting RNA.

FIG. 15 depicts one embodiment of the cDNA library preparation methods of the invention, wherein single stranded adaptors are ligated to the 5′ and the 3′ ends of the fragmented starting RNA.

FIG. 16 depicts one embodiment of the cDNA library preparation methods of the invention, wherein a single stranded adaptor is ligated to the 3′ end of the fragmented starting RNA, and a single-stranded 5′ end adaptor (B) is added after reverse transcription.

FIG. 17 depicts depicts one embodiment of the cDNA library preparation methods of the invention, wherein a partially double stranded adaptor is ligated to the 3′ end of the fragmented starting RNA, and a partially double stranded 5′ end adaptor (B) is added after reverse transcription.

FIGS. 18 (A and B) depict one embodiment of the cDNA library preparation methods of the invention, wherein the starting RNA need not be fragmented prior to reverse transcription. The RNA is reverse transcribed using random or semi-random primers, and the A′ and B adaptor sequences added to the resulting sscDNA by ligation.

FIG. 19 depict one embodiment of the DNA library preparation methods of the invention, wherein adapted DNA libraries are derived from starting DNA.

### DETAILED DESCRIPTION OF THE INVENTION

Unless defined otherwise, all technical and scientific terms used herein have the same meaning as commonly understood by one of ordinary skill in the art to which the invention pertains. Although a number of methods and materials similar or equivalent to those described herein can be used in the practice of the present invention, the preferred materials and methods are described herein.

The methods of the invention provide a number of benefits and advantages over existing cDNA library production methods. These advantages include (1) a small initial mRNA amount (i.e., from 5 ng to 500 ng with 10 ng to 200 ng being a typical starting amount) requirement, (2) the elimination of 3′ bias as compared to conventional cDNA library production and sequencing, (4) a faster process which involves less overall preparation, (5) the elimination of cloning and amplification of the material to be sequenced, and (6) the preservation of directionality information (sense or antisense direction) throughout the cDNA production process.

Overview:

The methods of the invention provide significant improvements over traditional cDNA sequencing protocols in that the resultant cDNA library contains significantly reduced 3′ bias for all transcript types. The provided methods overcome the inherent problem with the processivity of the reverse transcriptase by fragmenting the starting RNA to a uniform size range (150 to 500 nucleotides) which can be reverse transcribed feasibly without significant premature termination by reverse transcriptase. If the starting RNA is an mRNA, the fragments would randomly span each of the transcripts represented in the sample. This pool of fragmented RNA then undergoes a reverse transcription reaction driven by a semi-random primer (5′-P-TNNTN₆-3′) (SEQ ID NO:1).

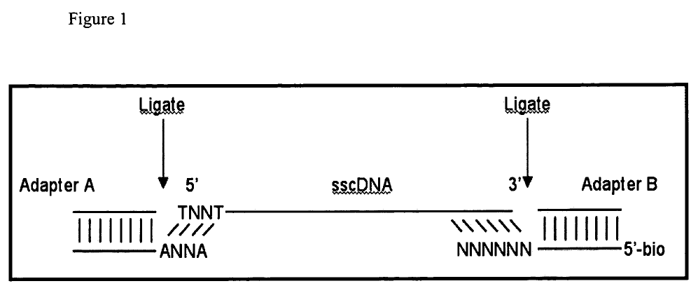

The use of a semi-random primer results in a uniformly random reverse transcription of all of the fragments of the different mRNAs and significantly, this technique does not favor the 3′ end over the 5′ end of the RNAs (e.g., transcripts). The primer is designed to be semi-random for two reasons. First, the randomness allows it to prime across all fragments within the RNA pool allowing full coverage of each transcript. Second, the TNNT portion (FIG. 1) of the primer may be used as a directional anchor site in the subsequent ligation reaction.

One advantage of the methods is that traditional second strand synthesis to make double stranded cDNA is not performed, which saves time and further avoids any artifacts due to in vitro nucleic acid synthesis. Instead, a ligation reaction is performed to attach the forward (or A-adaptor) and reverse (or B-adaptor) adaptors to the sscDNA. The A and B adaptors provide directional information for any downstream sequencing protocol (FIG. 1).

The adaptor sets (i.e., the A and B adaptors) are designed in a manner that allows directional ligation of the forward and reverse adaptors resulting in attaching the forward to the 5′ end and the reverse to the 3′ end of the sscDNA molecules. Each adaptor set used in the ligation are made up of two primers that are complementary however one of the primers is longer than the other and thus results in an overhanging segment. A schematic representation of the adaptor units used in the ligation reaction is shown in FIG. 1. The uncomplementary part of the longer primer will be used as an anchoring unit to anneal to the sscDNA molecules. Once this anchoring is done the shorter primer can be ligated to the 5′ or 3′ ends of the sscDNA. A schematic representation of the directional annealing of the adaptor units to the sscDNA and where the ligation takes place is shown in FIG. 1.

Many methods are available for isolating the ligated sscDNA from unligated material. In one preferred method, one or both of the adaptors may be biotin labeled at the longer strand (the non ligating strand). Commercially available streptavidin magnetic beads, such as MyOne (Dynal) are used to purify the ligated molecules from the ligation reaction. After the unligated material has been washed from the magnetic beads the sscDNA molecules are melted off. This is possible because only the non-ligating strands of the adaptors are biotinylated. The melting separates the ligating strand which is ligated to the cDNA and releases the ligating strand-cDNA structure into solution. This sscDNA may be purified from solution to generate the final sscDNA library that is ready for sequencing. Many methods of purifying sscDNA from solution are known. In certain embodiments, as a Sephacryl S-400 columns may be used for purification. In a preferred embodiment, the sscDNA is purified using RNAclean (Agencourt) to help remove the majority of the very small fragments as well as the unligated primers of the adaptors.

In one embodiment, the B adaptor set is biotin labeled so that the ligated cDNA molecules can be isolated from the non-ligated sscDNA molecules as well as the unligated adaptors using streptavidin coated magnetic beads. The sscDNA is melted from the beads and undergoes a cleanup step before generating the final sscDNA library. This library is then quantitated and diluted to the proper concentration for direct sequencing. Direct sequencing may be performed, for example, using 454 Life Sciences sequencing protocols and apparatus. While sequencing using 454 Life Sciences technology is preferred, the sequencing may be performed using any technique including the traditional technique of cloning and manual sequencing. Such methods of manual sequencing include, but are not limited to, Maxam-Gilbert sequencing, Sanger sequencing, sequencing-by-synthesis, such as, for example, pyrosequencing. Another method of sequencing involve PCR amplification of the individual sscDNA using primers designed to hybridize to known sequences on either end of the sscDNA (i.e., the A adaptor and B adaptor regions) followed by sequencing.

Having provided an overview of the strategy for generation of RNA libraries, each individual step of the methods of the invention is described in more details below.

Starting RNA

The methods of the invention may be used to sequence any natural or synthetic RNA including, at least, messenger RNA, ribosomal RNA, transfer RNA, viral RNA and micro RNA. One preferred source of RNA is cellular RNA. Cellular RNA may be isolated using known methods, such as isolation using 8M guanidinium HCl, or Trizol reagent. One of ordinary skill in the art is familiar with techniques commonly used to handle RNA, such as the use of diethylpyrocarbonate (DEPC)-treated water in all solutions that come into contact with the RNA of interest. The RNA can, but need not be, poly(A)-enriched. If poly(A) enriched RNA is desired, it may be obtained using any method that yields poly(A) RNA. Such methods include, for example, passing and binding a solution of poly(A) RNA over an oligo(dT) cellulose matrix, washing unbound RNA away from the matrix and releasing poly(A) RNA from the matrix with low ionic strength buffer (low salt buffer). Other methods of isolating poly(A) RNA include the use of oligo(dT) coupled magnetic media, such as oligo(dT) primed magnetic beads (Dynal).

RNA Fragmentation

The starting RNA may be fragmented by any method known in the art including mechanical shearing, sonication, and nebulization.

It should be noted that fragmentation is an optional step. The methods of the invention may be performed without RNA fragmentation.

Furthermore, the method of the invention is applicable to any size of RNA, produced with or without fragmentation, starting from RNAs of 10 bases, 20 bases to RNAs of 1 kb, 10 kb or more. The upper limit of RNA size is dependent of the processivity of the RNA reverse transcriptase. This upper limit would be expected to rise with the discovery of novel RNA reverse transcriptase or genetically engineered reverse transcriptase with greater processivity. Examples of RNAs in the lower size range include micro-RNA and fragmented or degraded RNA.

One preferred method for fragmenting starting RNA is heat-induced fragmentation of mRNA in the presence of potassium and calcium ions. Briefly, RNA is placed in a solution of 40 mM Tris-acetate, 100 mM potassium acetate and 31.5 mM magnesium acetate and incubated at 82° C. until the desired amount of fragmentation is achieved. We have found, under the above referenced Tris/potassium acetate/magnesium acetate solution, that a 2 minute incubation is sufficient to reduce RNA to a size of about 150 to 500 bases. Fragmentation may be monitored, for example, by gel electrophoresis or by Bioanalyzer (Agilent). Naturally, ion concentrations, incubation temperatures, and time adjustments may be necessary to adapt the fragmentation technique to different environments.

Following fragmentation, the RNA may be purified using known techniques. One method of RNA purification is to desalt the RNA sample. Desalting may be achieved using a commercially available kit (e.g., a spin column) from a commercial supplier such as Qiagen.

Single Strand cDNA (sscDNA) Synthesis:

Following fragmentation, the RNA is reverse transcribed into cDNA using reverse transcriptase. In one preferred embodiment, the first strand cDNA synthesis is performed using a semi-random primer with the sequence 5′-P-TNNTNNNNNN-3′ (SEQ ID NO:1) where N represents random sequence (A, G, C or T) and P is a 5′ phosphate. The primer is designed to prime randomly over the fragmented mRNAs using the 3′ NNNNNN region (SEQ ID NO:17). While it is preferred that this poly(N) region be 6 bases in length, poly(N) regions of 7 bases, 8 bases, 9 bases, or 10 bases are also contemplated. The primer also contains an adaptor sequence (5′-TNNT-3′) that may be used for the subsequent directional ligation of the forward adaptor. It is understood that the sequences of the primers disclosed herein are used for illustration purposes and that the Ts in the primer sequence TNNTNNNNNN (SEQ ID NO: 1) may be replace with any two known bases. For example, the following primers would also work in the practice of the present invention: ANNANNNNNN (SEQ ID NO:2), GNNGNNNNNN (SEQ ID NO:3), CNNCNNNNNN (SEQ ID NO:4), ANNGNNNNNN (SEQ ID NO:5), ANNCNNNNNN (SEQ ID NO:6), ANNTNNNNNN (SEQ ID NO:7), GNNANNNNNN (SEQ ID NO:8), GNNCNNNNNN (SEQ ID NO:9), GNNTNNNNNN (SEQ ID NO:10), CNNANNNNNN (SEQ ID NO:11), CNNGNNNNNN (SEQ ID NO:12), CNNTNNNNNN (SEQ ID NO:13), TNNANNNNNN (SEQ ID NO:14), TNNGNNNNNN (SEQ ID NO:15) and TNNCNNNNNN (SEQ ID NO:16).

Any of the primers, oligonucleotides, nucleotides, nucleosides and nucleobases of the present invention may contain one or more chemical modifications and substitutions know in the art, such as phosphorothioate substitutions, modified sugar moieties such as 2′-O-methyl or 2′-O-ethyl-substituted sugars, chemiluminescent or fluorescent labels such as but not limited to horseradish peroxidase, rhodamine, fluorescein, and Alexa tags available from Molecular Probes, mass tags, blocking or protective groups, and haptens such as biotin.

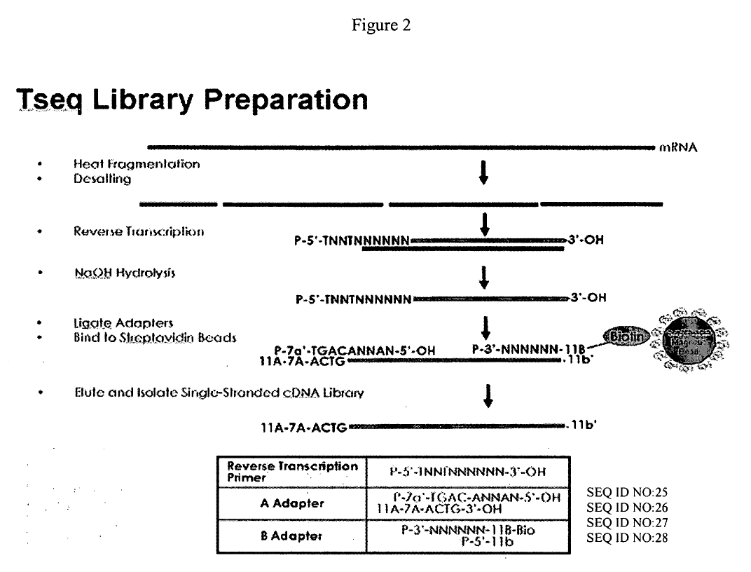

As stated earlier, the use of a 5′ primer with a unique 5′ sequence region of (adaptor A)-NNNNNN (SEQ ID NO:17) is contemplated. Such a primer, with an adaptor sequence at its 5′ end, would save the subsequent ligation of a first adaptor (i.e., save one ligation step). Following cDNA synthesis with such a primer, only a 3′ adaptor ligation is needed. Using the primer and reverse transcriptase, a sscDNA may be synthesized from the fragmented starting RNAs. The sequence of adaptor sequences may be found, for example, in FIG. 2.

Ligation of Adaptors:

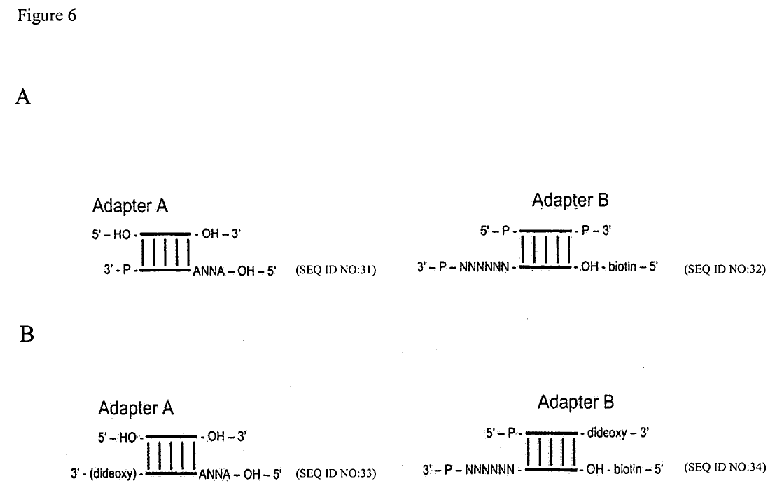

After the first strand synthesis the sscDNA is purified and placed into a ligation reaction to add adaptor sequences to its 5′ and 3′ end. The adaptors are short nucleic acids with a partial single stranded region designed to hybridize and ligate to the sscDNA in a directional fashion (e.g., adaptor A to the 5′ end and adaptor B to the 3′ end of the sscDNA see FIG. 1). Sample adaptor structures are shown in FIG. 6.

Adaptor A may be double stranded DNA with an overhanging 5′ single stranded region. For example, Adaptor A, which is partially single stranded and partially double stranded, may comprise the sequence

| | |
|---|---|
| 5′-OH-nnnnnn-OH-3′ | (SEQ ID NO:17) |
| \|\|\|\|\|\| | |
| 3′dideoxy-nnnnnnanna-OH-5′ | (SEQ ID NO:29) |

The 3′ dideoxy prevents ligation of the strand to another nucleic acid.

This sequence will hybridized specifically to the 5′ regions of the sscDNA which was made from elongating from a primer of the sequence 5′-P-tnntnnnnnn-3′ (SEQ ID NO:1) (See, FIG. 1). As discussed above, the underlined bases of Adaptor A is designed to be complementary to the underlined bases of the primer sequence. As a further illustration, if the primer sequence were 5′-gnngnnnnnn-3′ (SEQ ID NO:3), then Adaptor A should have a sequence of

| | |
|---|---|
| 5′-OH-nnnnnn-OH-3′ | (SEQ ID NO:17) |
| \|\|\|\|\|\| | |
| 3′dideoxy-nnnnnncnnc-biotin-5′ | (SEQ ID NO:30) |

Adaptor B may be any double stranded DNA with an overhanging 3′ region. For example, adaptor B may have the sequence:

| | |
|---|---|
| 5′-P-nnnnnn-3′dideoxy | (SEQ ID NO:17) |
| \|\|\|\|\|\| | |
| 3′-P-nnnnnnnnnn-OH-5′ | (SEQ ID NO:18) |

This adaptor can hybridize to the 3′ end of any single stranded DNA and the shorter strand of adaptor B can be ligated to the single stranded DNA.

It should be noted that the dideoxy shown in the figures and text of this disclosure represents a blocking group to prevent ligation of the nucleic acid. These dideoxy groups may be replaced with any blocking group that is functionally equivalent (i.e., a blocking group that can prevent ligation of the nucleic acid strand). Alternativley, no blocking groups may be used.

The double stranded region of Adaptor A and Adaptor B may comprise any sequence—including a random sequence. In a preferred embodiment, Adaptor B may comprise a restriction endonuclease cleavage site, a known sequencing primer site, or both in its double stranded region.

In a more preferred embodiment, the double stranded region of Adaptor A and Adaptor B may comprise one member of a binding pair—a binding moiety—for the subsequent purification of the primer. Each of Adaptor A and Adaptor B comprise two strands—a strand which can be ligated to a single stranded nucleic acid and a strand which cannot—referred to herein as the “ligating strand” and the “non-ligating strand.” In a preferred embodiment, the non-ligating strand of Adaptor A or Adaptor B contains one member of a binding pair—such as biotin. Useful binding pairs include, for example, biotin/avidin, biotin/streptavidin, poly-HIS region/NTA, FLAG/anti FLAG antibody, antigen/antibody or antibody fragment and the like. Purification significantly reduces the formation of concatemer such as primer dimers.

The generation of the single stranded cDNA library is complete following the ligation of the adaptors. The cDNA library may be used for any molecular biology procedure that requires a cDNA library.

In one embodiment, the cDNA is produced from the RNA of a single tissue. In other embodiments, the cDNA may be produced from RNA of multiple tissues, one or more cells, bodily fluids, one or more organisms, environmental samples, biofilms, one or more bacteria, one or more archae, one or more fungi, one or more plants, one or more animals, one or more humans, virus, retrovirus, phage, parasite, tumor or tumor sample, and/or biological specimen. The sequencing of the entire cDNA library will allow a researcher to determine the level of expression of each of the genes in the single cell or single tissue (i.e., transcription profiling). In a preferred embodiment, the sequencing is performed using methods and apparatuses from 454 Life Sciences. Methods for direct sequencing of nucleic acids may be found in co-pending U.S. patent applications Ser. No. 10/767,779 filed Jan. 28, 2004, U.S. Ser. No. 60/476,602, filed Jun. 6, 2003; U.S. Ser. No. 60/476,504, filed Jun. 6, 2003; U.S. Ser. No. 60/443,471, filed Jan. 29, 2003; U.S. Ser. No. 60/476,313, filed Jun. 6, 2003; U.S. Ser. No. 60/476,592, filed Jun. 6, 2003; U.S. Ser. No. 60/465,071, filed Apr. 23, 2003; and U.S. Ser. No. 60/497,985; filed Aug. 25, 2003.

Purification of the Generated cDNA Library:

The sscDNA may be purified in an optional step. One method of purification is by size selection. The RNA fragment generated from the starting RNA is between 100 bases to 1000 bases in size, preferably between 150 bases to 500 bases in size and the sscDNA generated from the RNA fragment is expected to be comparable in size. This size is larger than the size of the adaptors and primers. Thus, cDNA may be purified by size fractionation—which may be performed by column chromatography (including spin columns), by polyacrylamide gel electrophoresis, by agarose gel electrophoresis, or by use of SPRI beads (RNAclean, Agencourt).

In the case where a binding moiety is incorporated into the ligating strand, the sscDNA may be retrieved by affinity binding. For example, unligated adaptors and unligated strands of adaptors may be removed by denaturing conditions such as heat treatment or alkaline treatment. Following denaturing treatment, the ligated sscDNA comprising one member of the binding pair (e.g., biotin) may be bound to a solid support comprising the other member of the binding pair (e.g., avidin coated magnetic beads). After washing to remove unbound nucleic acid, the purified sscDNA may be separated from the solid support.

In the case where the binding moiety is incorporated into the non-ligating strand, the sscDNA may be retrieved by binding the non-ligating strand comprising a member of the binding pair (e.g., biotin) to a solid support comprising the other member of the binding pair (e.g., avidin coated magnetic beads). After washing, the sscDNA may be collected by denaturing conditions. Under denaturing conditions, the sscDNA, hybridized to the non-ligating strand, is released into solution while the non-ligating strand will remain bound to the solid support. Thus, the solution may be collected with the purified sscDNA.

The methods of the invention may be used in various ways including, but not limited to: the construction of subtractive cDNA libraries and transcription profiling (Shimkets et al. (1999). “Gene expression analysis by transcript profiling coupled to a gene database query.” Nat Biotechnol 17(8): 798-803).

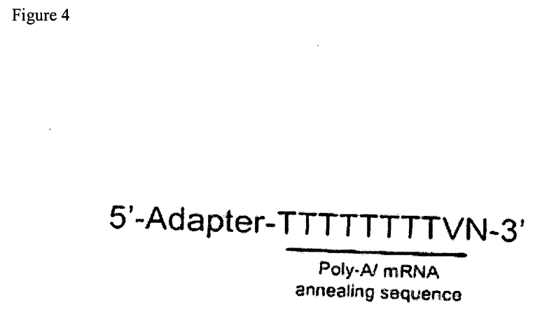

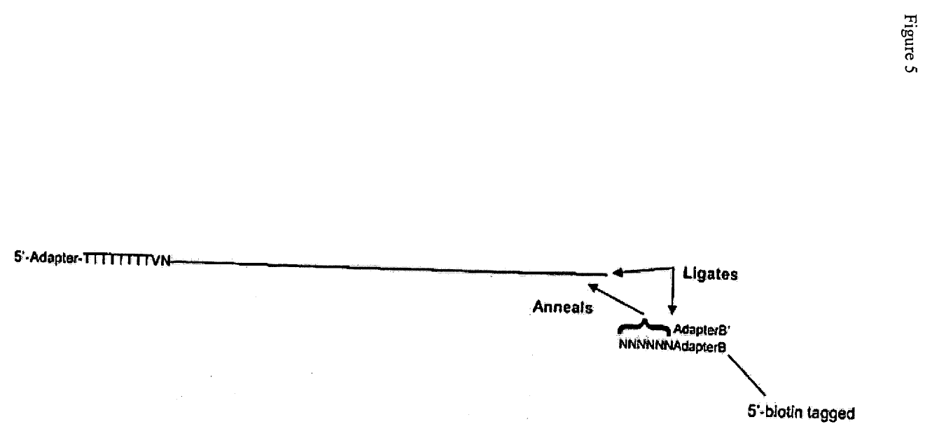

In a second embodiment, the methods of the invention may be directed to transcript counting. In transcript counting, the first primer is designed to hybridize to the poly-A tail of messenger RNA. The produced cDNA library would be enriched for cDNA sequences near the poly A tail. In this method, RNA is fragmented in the same fashion as the transcript sequencing (TSEQ) protocol described above. However in this case, it is highly preferred to use poly A isolated RNA. The primer for the synthesis of the first (and most of the time only) strand of cDNA has two regions. The first region is a 5′ region designed to hybridize to a polyA regions. This could be an oligo dT region. The second region contains the adaptor sequence which is represented by the VN in FIG. 4.

As an additional option, the primer may contain an additional 5′ region which comprises the sequence of an adaptor. Thus, the sequence of the primer may be:

| | |
|---|---|
| 5′-(Adaptor A)-ttttttttv-3′. | (SEQ ID NO:19) |

In a more preferred embodiment, the sequence of the primer may be:

| | |
|---|---|
| 5′-(Adaptor A)-ttttttttvn-3′. | (SEQ ID NO:20) |

Throughout this specification “v” is used to represent a DNA or RNA base which is a, g, or c. In other words, v is any base but t or u.

Alternatively, the primer may contain a gene specific or gene family-specific sequence in order to bias the library construction to a subset of genes.

If the primer does not contain an adaptor sequence (i.e. the primer has the structure shown for SEQ ID NO:19 or SEQ ID NO:20 as shown above, but lacks the “(Adaptor A)” sequence), the adaptor sequence may be ligated after cDNA synthesis.

After cDNA synthesis, an adaptor structure of

(SEQ ID NO:35)

```
                5′(Adaptor B′)3′dideoxy
                      ||||||||||
3-P-NNNNNN(Adaptor B)-biotin-5′
```

may be used, wherein Adaptor B and Adaptor B′ are complementary sequences. This adaptor structure may be ligated to the 3′ end of the cDNA (See FIG. 5). Note that after ligation, one strand is biotinylated and the ligated cDNA may be purified by a streptavidin column or streptavidin bead.

The resulting cDNA may be used for sequencing in the same manner as the Tseq sequencing describe above.

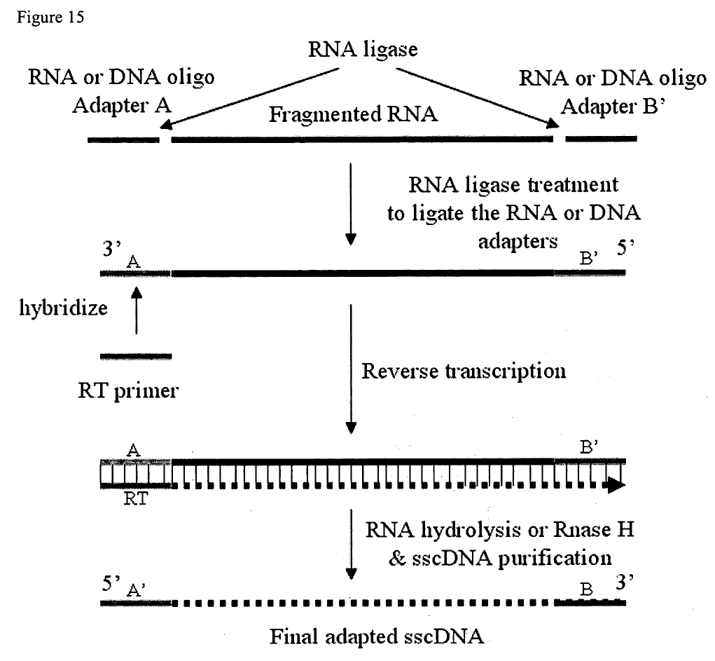

In an additional embodiment, following fragmentation of the starting RNA, single stranded oligonucleotide adaptors (which may be DNA or RNA) may be ligated to the fragmented RNA (for example by use of T4 RNA Ligase). The adaptor ligated to the 3′ end of the RNA may be Adaptor A, and the adaptor ligated to the 5′ end of the RNA may be Adaptor B′, as depicted in FIG. 15. The subsequent reverse transcription may be initiated from an RT primer complementary to Adaptor A. Following reverse transcription, the RNA strands may be removed by any of the methods disclosed herein, including hydrolysis or Rnase H treatment, after which the final adapted sscDNA can be purified. This final adapted sscDNA comprises A′ adaptor sequences at the 5′ end and B adaptor sequences at the 3′ end.

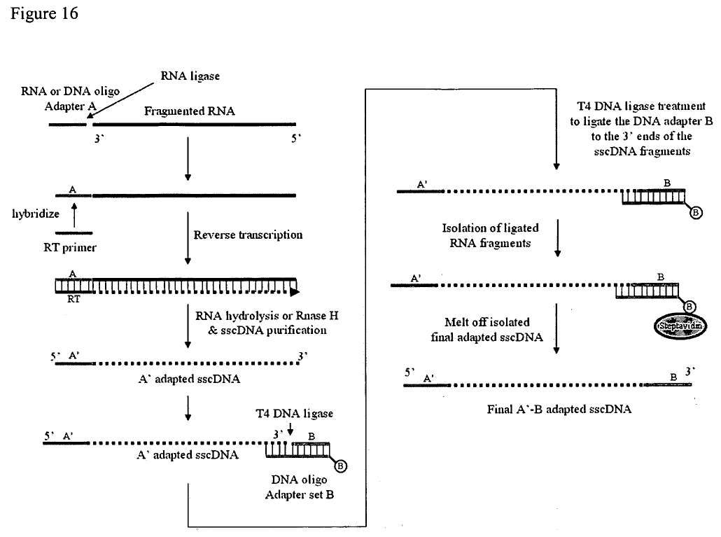

In another embodiment (FIG. 16), following fragmentation of the starting RNA, a single stranded oligonucleotide adaptors (which may be DNA or RNA) may be ligated to the 3′ end of the fragmented RNA (for example by use of T4 RNA Ligase). The subsequent reverse transcription may be initiated from an RT primer complementary to Adaptor A. Following reverse transcription, the RNA strands may be removed by any of the methods disclosed herein, including hydrolysis or Rnase H treatment. The resulting A′ adapted sscDNA may ligated to a partially double stranded oligonucleotide Adaptor set B as shown FIG. 16. One strand of oligonucleotide Adaptor set B comprises a single stranded portion of random or semi-random sequence at its 3′ end, and a biotin or similar affinity label at its 5′ end. The ligation products may then be captured by avidin or streptavidin, and the final A′-B adapted sscDNA melted off (FIG. 16), as described elsewhere herein.

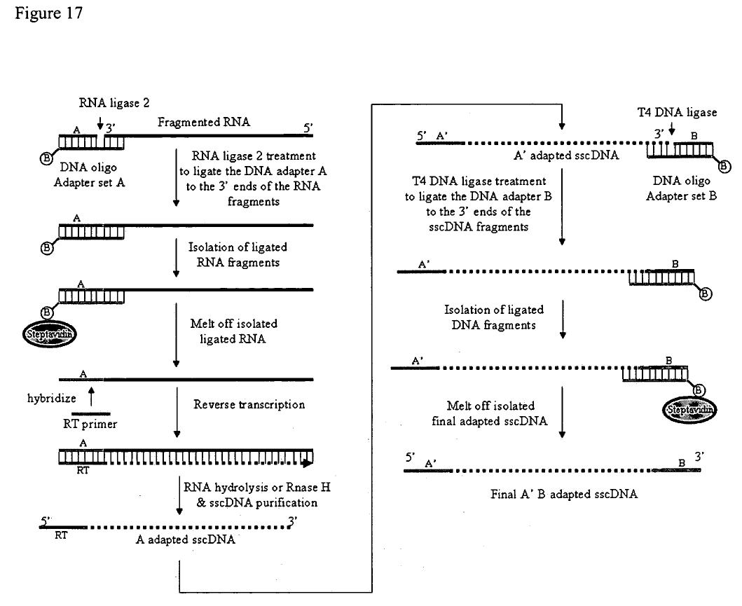

In yet another embodiment (FIG. 17), following fragmentation of the starting RNA, a partially double stranded oligonucleotide Adaptor set A is ligated to the 3′ end of the RNA, as shown FIG. 17. One strand of oligonucleotide Adaptor set A comprises a single stranded portion of random or semi-random sequence at its 3′ end, and a biotin (or other suitable affinity label) at its 5′ end. The ligation products may then be captured by avidin or streptavidin (or other suitable binding partner), and the ligated RNA melted off. Subsequently, reverse transcription may be initiated from an RT primer complementary, at least in part, to Adaptor A sequences. Following reverse transcription, the RNA strands may be removed by any of the methods disclosed herein, including hydrolysis or Rnase H treatment, after which the A-adapted sscDNA can be purified. To the 3′ end of this A-adapted sscDNA, a partially double stranded DNA oligonucleotide Adaptor set B is ligated (e.g. with T4 DNA ligase); one strand of oligonucleotide Adaptor set B comprises a single stranded portion of random or semi-random sequence at its 3′ end, and a biotin (or other suitable affinity label) at its 5′ end, as shown FIG. 17. The ligation products may then be captured by avidin or streptavidin (or other suitable binding partner), and the final A′-B adapted sscDNA melted off (FIG. 17), as described elsewhere herein.

In this and embodiment, and other embodiments described herein, the skilled artisan will appreciate that undesirable adaptor-adaptor ligation events may be prevented by placing suitable chemical structures (e.g., presence or absence of phosphate groups, or dideoxy groups) on the 3′ and/or 5′ ends of the oligonucleotides, as appropriate.

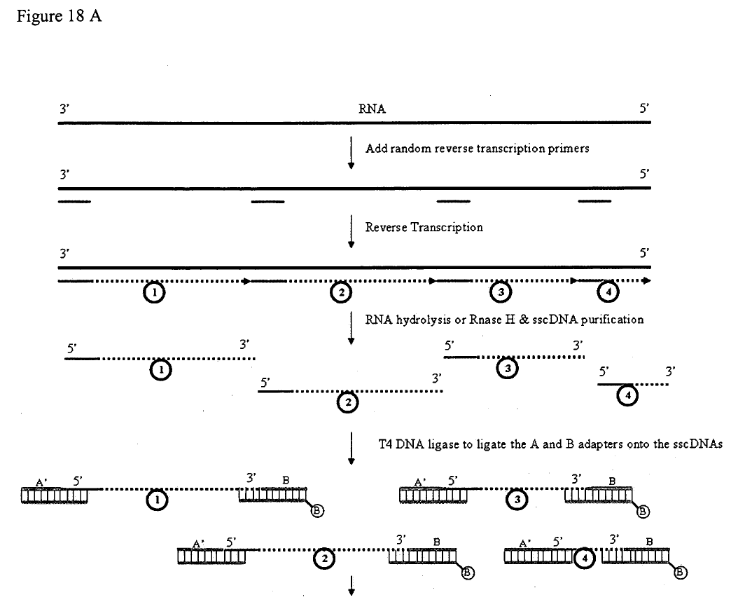

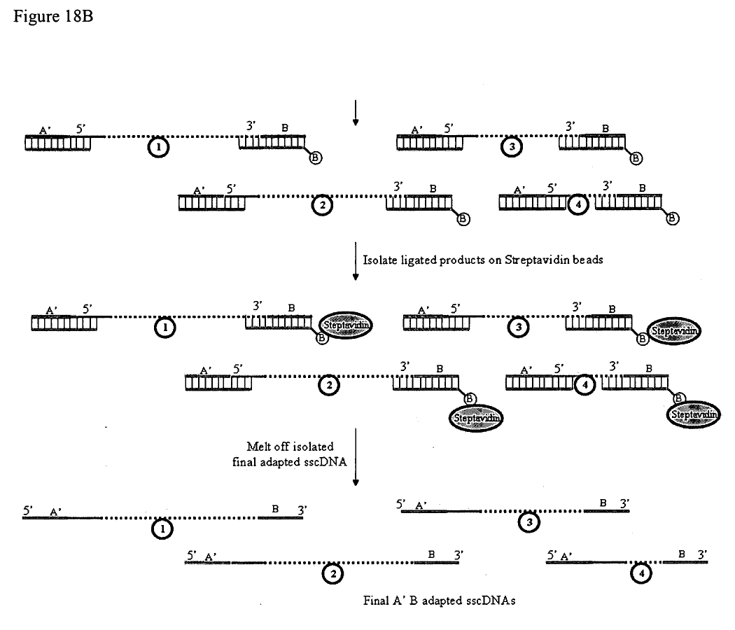

In certain embodiments of the invention, methods for the preparation of cDNA libraries do not require fragmentation of the starting RNA (e.g. FIGS. 18 A and B). In these embodiments, random or semirandom reverse transcription primers are annealed to the unfragmented starting RNA, and reverse transcription is carried out. For example, the reverse transcription primers may be comprised of a random or semirandom 5′ portion and a constant 3′ portion. If the reverse transcriptase enzyme used is non-strand displacing, reverse transcription may continue from each annealed primer until the next annealed primer, or until the 5′ end of the RNA is reached. The skilled artisan will appreciate that the average length of the resulting sscDNA fragments is dependent upon, inter alia, the ratio of primers to starting RNA. Following reverse transcription, the RNA strands may be removed by any of the methods disclosed herein, including hydrolysis or Rnase H treatment, after which the sscDNA fragments, each comprising a reverse transcription primer at its 5′ end, can be purified. The 5′ end of the sscDNA may subsequently be ligated to the partially double stranded oligonucleotide Adaptor set A′ (for example by use of T4 DNA Ligase). Adaptor set A′ comprises one strand having a single stranded portion of random or semi-random sequence at its 5′ end. The 3′ end of the sscDNA may be ligated to the pratially double stranded oligonucleotide Adaptor set B (for example by use of T4 DNA Ligase). Adaptor set B comprises one strand having a single stranded portion of random or semi-random sequence at its 3′ end, and a biotin (or other suitable affinity label) at its 5′ end (FIG. 18 A). The ligation products may then be captured by avidin or streptavidin (or other suitable binding partner), and the final A′-B adapted sscDNA melted off (FIG. 18B), as described elsewhere herein. The “bottom” strand of Adaptor set A′ (according to FIG. 18) will also melt off, and can be separated from the desired final A′-B adapted sscDNA by any of a number of size selection procedures know in the art and described herein, such as SPRI beads.

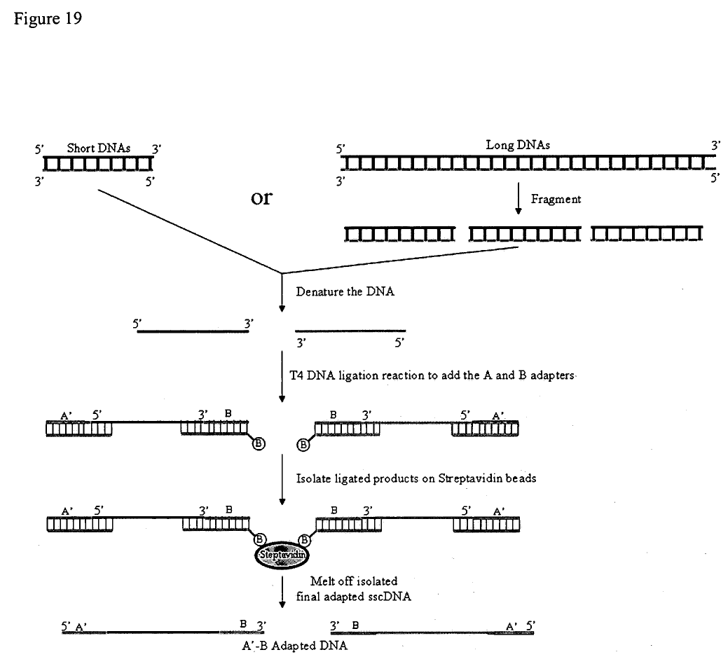

Certain embodiments of the invention are directed to the generation of DNA libraries, rather than cDNA libraries. In these embodiments, the starting material is either single stranded or double stranded DNA. The starting DNA may be derived from any biological (cellular or viral) or synthetic source. If the starting DNA is single stranded, it may, e.g., have originated from denatured double stranded DNA, or may be isolated from a single stranded DNA virus. If the length of the starting DNA fragments exceed the length required for the desired DNA library, it can be fragmented by any method known in the art, be it enzymatic (e.g. restriction enzymes), chemical, or mechanical (e.g. shearing). If the starting DNA is double-stranded, the fragments are denatured, for example by heat treatment, to produce ssDNA fragment. The 5′ end of the ssDNA may subsequently be ligated to the partially double stranded oligonucleotide Adaptor set A′ (for example by use of T4 DNA Ligase). Adaptor set A′ comprises one strand having a single stranded portion of random or semi-random sequence at its 5′ end. The 3′ end of the ssDNA may be ligated to the partially double stranded oligonucleotide Adaptor set B (for example by use of T4 DNA Ligase). Adaptor set B comprises one strand having a single stranded portion of random or semi-random sequence at its 3′ end, and a biotin (or other suitable affinity label) at its 5′ end (FIG. 19). The ligation products may then be captured by avidin or streptavidin (or other suitable binding partner), and the final A′-B adapted ssDNA melted off, as described elsewhere herein. The “bottom” strand of Adaptor set A′ (according to FIG. 19) will also melt off, and can be separated from the desired final A′-B adapted ssDNA by any of a number of size selection procedures know in the art and described herein, such as SPRI beads.

Throughout this disclosure, the term “biotin” “avidin” or “streptavidin” have been used to describe a member of a binding pair. It is understood that these terms are merely to illustration one method for using a binding pair. Thus, the term biotin, avidin, or streptavidin may be replaced by any one member of a binding pair. A binding pair may be any two molecules that show specific binding to each other and include, at least, binding pairs such as FLAG/FLAG antibody; Biotin/avidin, biotin/streptavidin, receptor/ligand, antigen/antibody, receptor/ligand, polyHIS/nickel, protein A/antibody and derivatives thereof. Other binding pairs are known and published in the literature.

All patents, patent applications and references cited anywhere in this disclosure is hereby incorporated by reference in their entirety. Other embodiments and advantages of the invention are set forth, in part, in the description which follows and, in part, will be obvious from this description and may be learned from practice of the invention.

The invention will now be further described by way of the following non-limiting Examples.

### EXAMPLES

### Example 1

### Material and Methods The protocol has been developed to work starting with 200 ng of mRNA material. A schematic of this protocol is shown in FIG. 2.

The starting volume for the process was 10 μl. The sample was placed on ice and 2.5 μl of 5× Fragmentation buffer (0.2 M Tris-acetate, 0.5 M potassium acetate and 157.5 mM magnesium acetate) was added to the sample and mixed well. The sample was placed in a thermocycler and heated to 82° C. and allowed to incubate at 82° C. for 2 minutes. Immediately following the incubation at 82° C., the sample was transferred back to ice.

Salt was removed from the sample in a desalting step. Methods of desalting samples are well known. The protocol used here involved passing the sample through an Autoseq G-50 column (Amersham Biosciences) according to the manufacture's instructions. The recovered material of approximately 20 μl volume was dried down to 10 μl by centrifuging under vacuum (2 Torr) at 45° C. in a speed-vac (Savant Speed Vac Concentrator Systems).

Annealing of the reverse transcription primer to the mRNA templates was performed by adding 2 μl of the reverse transcription primer (200 μM of 5′-P-TNNTNNNNNN-3′, where P represents a phosphate, SEQ ID NO:1) to the fragmented mRNA. Then, the sample was heated to 70° C. for 10 min in a thermocycler and cooled on ice.

8.5 microliters of reverse transcription mix (4.0 μl of 5× Superscript II First Strand Buffer, 2.0 μl of 0.1 M DTT, 1.0 μl of dNTP mix (10 mM each), 1.0 μl of Superscript II enzyme at 50 units/μl (Invitrogen) and 0.5 μl of RNase Out at 125 units/μl (Invitrogen)) was added to the reaction tube. The reaction tube was mixed well and incubated at 45° C. for 1 hour. After this reaction the sscDNA molecules were isolated by adding 15 μl of the denaturizing solution (0.5 M NaOH, 0.25 M EDTA pH 8.0), mixed and incubated at 65° C. for 20 minutes. The reaction was terminated by the addition of 20 μl of neutralization buffer. Then, the reaction was purified using the Qiagen MinElute DNA Purification Columns following manufacturer's instruction with the exception of the elution volume. The reaction was eluted with 12 μl of 10 mM Tris-Cl pH 7.5.

Ligation of Adaptor A and Adaptor B was set up by adding 6.5 μl of the ligation mix (1.0 μl of 25 μM Adaptor A, 1.0 μl of 50 μM Adaptor B, 1.8 μl 10×T4 ligase buffer, 2.2 μl of water and 0.5 μl of the high concentration T4 DNA Ligase at 2000 units/μl (New England Biolabs)) to the sample. The sample was mixed and incubated at 22° C. for 12 hours.

Ligated products are isolated through the biotin tagged B adaptor binding to MyOne Streptavidin magnetic beads (Dynal) according to the following procedure. It is understood that any form of magnetic bead bound to a corresponding binding pair such a streptavidin bead would work. The ligation reaction volume is increased to 100 μl by the addition of 1×TE pH 7.5. Then a slurry containing 100 μl of washed magnetic beads is added to the sample. The sample was mixed for 10 to 15 minutes at room temperature and then the beads were washed to remove all unbound material.

The sscDNA was melted and eluted from the beads with 100 μl of elution buffer (25 mM NaOH, 1 mM EDTA, 0.1% Tween-20). The eluted material was transferred to a new tube and neutralized with 10 μl of neutralization buffer (250 mM HCl, 250 mM Tris-CL pH 8.0). After adding the neutralization buffer the sample was passed over a Sephacryl S-400 chromatography column to remove small fragments from the sscDNA sample. The sample was then purified on a Quiagen MinElute column as per the manufacture's protocol. The final sscDNA was eluted from the column with 18 μl of 10 mM Tris-HCl pH 7.5 and a small aliquot is used to QC the library.

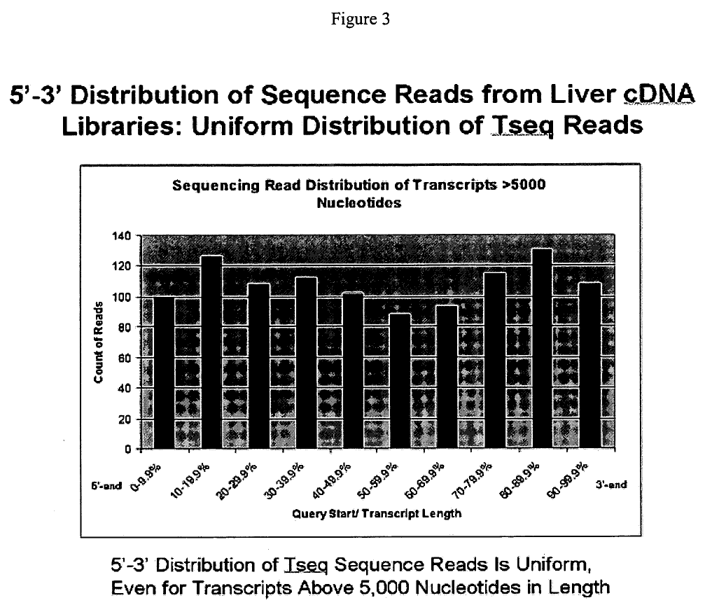

A study of this protocol performed on a mouse liver mRNA sample provided a large amount of sequence data that covered transcripts of all sizes. To determine the sequence coverage of longer transcripts, the number of hits per region of all of the transcripts that were greater than 5000 nucleotides was plotted. It was observed that there was a uniform distribution of sequence coverage across the full length of these transcripts suggesting that even the transcripts of greater than 5000 nucleotides in length showed little to no 3′ bias (refer to FIG. 3).

### Example 2

### cDNA Library Preparation and Sequencing of an Influenza Virus Genome

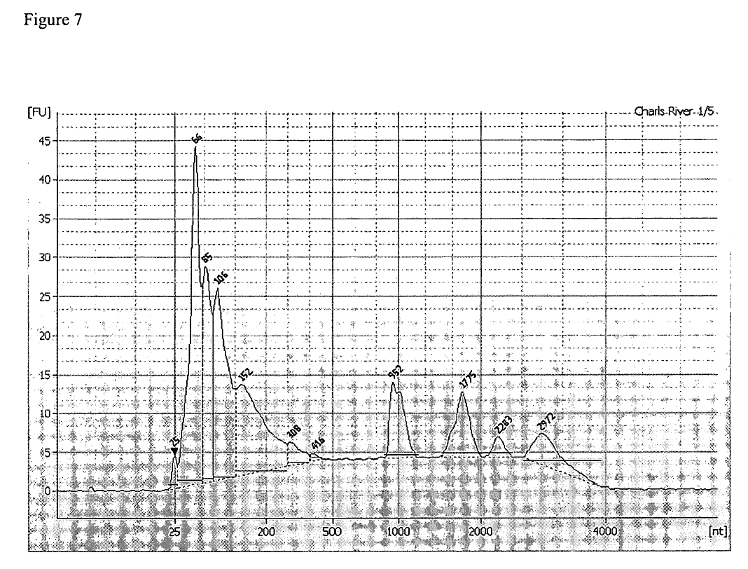

RNA genome material of influenza virus strain A/Puerto Rico/8/34 was purchased from Charles River Laboratories (Wilmington, Mass.). The influenza genome is known to comprise 8 segments of single-stranded negative-sense RNA. The total length of all segments is 13500 nt. The starting RNA material was found to be present in distinct size fractions corresponding to the segments of the viral RNA (FIG. 7). Various starting amounts (10 ng, 20 ng, 50 ng, or 200 ng) of RNA were used in the preparation of cDNA libraries.

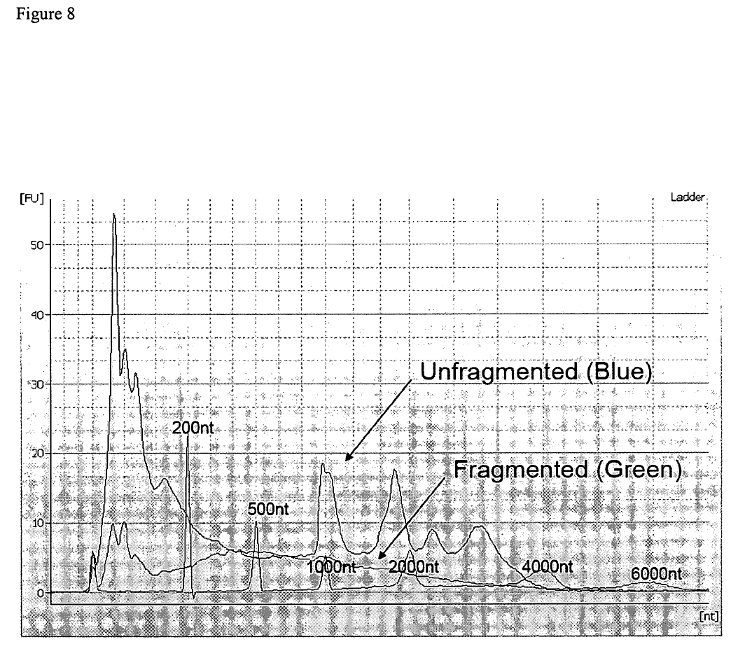

For RNA fragmentation, the starting amount of RNA, in a volume of 10 μl, was added to 2.5 μl of 5× Fragmentation Buffer (200 mM Tris-Acetate, 500 mM Potassium Acetate, 157.5 mM Magnesium Acetate, pH 8.1), vortexed briefly, and incubated at 82° C. for 2 minutes, then chilled on ice. For clean-up of the fragmented RNA, the sample volumes were adjusted to 50 μl with 10 mM Tris-HCl, pH 7.5. One hundred microliters of RNAClean bead mix (Agencourt, Beverly Mass.) was added, mixed, and incubated at room temperature for 10 minutes. The beads where then collected on a magnetic particle collector unit. The supernatant was discarded, and the beads washed twice with 70% ethanol. The beads were air dried, followed by elution of the RNA with 11 μl of 10 mM Tris-HCl ph 7.5, yielding approximately 9.5 μl of eluate. The fragmentation resulted in RNA of a broad size range, with a peak at approximately 500 nucleotides (FIG. 8).

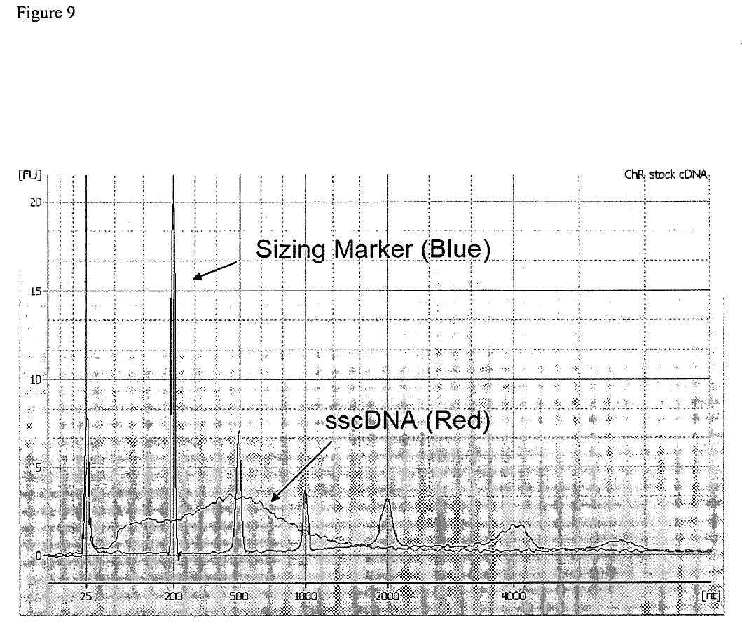

For preparation of single-stranded cDNA (sscDNA), the entire eluate was then mixed with 2 μl of 200 microM primer P-TNNTNNNNNN (SEQ ID NO: 1) and heated to 70° C. for 10 minutes, followed by rapid cooling on ice. Thereafter, 8.5 μl of ice cold reverse transcription mix (4 μl 5×SSII First Strand Buffer [Invitrogen, Carlsbad, Calif. ], 2 μl 0.1 M DTT, 1 μl of dNTP mix [10 mM each dNTP], 1 μl of Superscript II reverse transcriptase [Invitrogen], and 0.5 μl of RNase Out [Invitrogen]) were added, followed by mixing. The mixture was incubated at 45° C. for one hour, then placed on ice. 20 μl denaturation solution (0.5 M NaOH, 0.25 M EDTA) was added, mixed, and incubated at 65° C. for 20 minutes. cDNA neutralization solution (0.5 M HCl, 0.5 M Tris-Cl) was added (10-40 μl) to achieve a pH of 7-8.5. The samples were purified by addition of 1.5 volumes of RNAClean mix, and incubation at room temperature for 10-15 minutes. The beads where then collected on a magnetic particle collector unit. The supernatant was discarded, and the beads washed twice with 70% ethanol. The beads were air dried, followed by elution of the sscDNA with 25 μl of 10 mM Tris-HCl, pH 7.5. The size distribution of the sscDNA thus obtained centered around a peak at approximately 500 nucleotides (FIG. 9).

For ligation of adaptors, the SAD1F oligonucleotide was ligated to the 5′ end of the sscDNA and the SAD1R oligonucleotide was ligated to the 3′ end of the sscDNA. To this end, 6 μl of Adaptor/Buffer Mix (3 μl 10×T4 DNA Ligase Buffer [New England Biolabs, Ipswich, Mass.], 1 μl of 50 microM SAD1F/SAD1Fprime (1.2:1), 1 μl of 200 microM Bio-SAD1R/SAD1Rprime (1.2:1), and 1 μl of Quick Ligase or T4 DNA Ligase High Conc. [New England Biolabs]) was added to the sscDNA sample and incubated at 22° C. for 12 hours. Following this incubation, 1×TE (pH 8.0) was added to achieve ligated mix with a final volume of 100 μl. The sequences of the oligonucleotides are shown in Table 1.

TABLE 1

| | | | SEQ |
|---|---|---|---|
| | | | ID |
| Name | Sequence (5′-3′) | Modification | NO |
| SAD1F | GCC TCC CTC GCG CCA | None | 21 |
| (TCAG) | TCA G | | |
| SAD1F | N*A*N*NAC TGA TGG CGC | * = Phosphoro- | 22 |
| prime | GAG GGA* G*G*/3ddC | thioated Bases, | |
| (TCAG) | | 3′-Dideoxy-C | |
| SAD1R | GCC TTG CCA GCC CGC | 5′-Biotin, | 23 |
| (TCAG) | TCA GNN NN*N*N* | 3′-Phosphate, | |
| | | * = Phosphoro- | |
| | | thioated Bases | |
| SAD1R | CTC AGC GGG CTG GCA | 5′-Phosphate, | 24 |
| prime | AGG /3ddC | 3′-Dideoxy-C | |
| (TCAG) | | | |

The partially double stranded oligo nucleotide SAD1F/SAD1Fprime was prepared by combining the SAD1F and SAD1Fprime single stranded oligonucleotides at a 1:1.2 molar ratio, and annealing using the thermal program: 80° C. 5 min, 65° C. 7 min, 60° C. 7 min, 55° C. 7 min, 50° C. 7 min, 45° C. 7 min, 40° C. 7 min, 35° C. 7 min, 30° C. 7 min, 25° C. 7 min, 4° C. indefinite. The partially double stranded oligonucleotides SAD1R/SAD1Rprime was prepared from SAD1R and SAD1Rprime in the same manner.

For the isolation of the sscDNA library following adaptor ligation, first, 20 μl per sample of Streptavidin Magnetic beads (Dynal Biotech) were equilibrated in B&W Buffer+Tween (10 mM Tris-Cl pH 7.5, 1 mM EDTA pH 8.0, 2 M NaCl, 0.1% Tween-20), as follows. The beads were separated from the liquid in a magnetic particle capture unit, and the supernatant discarded. The beads were washed in 1 ml of B&W Buffer+Tween, separated from the liquid in a magnetic particle capture unit, and the supernatant discarded. The beads were then resuspended in 100 μl of B&W Buffer+Tween per 20 μl of starting bead volume, and added to the 100 μl of ligated mix (see above), and agitated for 15 minutes. The beads were separated from the liquid in a magnetic particle capture unit, and the supernatant discarded. The beads were washed in 200 μl of 0.5×B&W Buffer+Tween, and separated from the liquid in a magnetic particle capture unit, and the supernatant discarded. The beads were washed twice in 200 μl of Bead Wash Buffer (10 mM Tris-Cl pH 7.5, 1 mM EDTA pH 8.0, 30 mM NaCl, 0.1% Tween-20), each time separating the beads from the liquid in a magnetic particle capture unit, and discarding the supernatant. 100 μl of Bead Elution Buffer (25 mM NaOH, 1 mM EDTA, 0.1% Tween-20) was added and the sample agitated for 10 minutes at room temperature. The beads were separated from the liquid in a magnetic particle capture unit, and the supernatant (containing the sscDNA library) transferred to a new PCR tube.

For purification of the sscDNA library: to the sscDNA in Bead Elution Buffer, 140 μl of RNAClean Mix were added, followed by mixing, and incubation at room temperature for 10 minutes. The beads were separated from the liquid in a magnetic particle capture unit, and the supernatant discarded. The beads were washed twice in 70% ethanol, followed by air drying. The sscDNA was eluted in 30 μl of 10 mM Tris-Cl pH 7.5. The RNAClean procedure was repeated as above, except starting with 42 μl of RNAClean mix, and finally eluting the sscDNA with 12 μl of 10 mM Tris-Cl pH 7.5.

The sscDNA library thus obtained was PCR amplified. Two to three μl of final sscDNA eluate from above was added to 5 μl of 10× Advantage 2 PCR Buffer (Clontech, Mountain View, Calif.), 1.0 μl of SAD1F primer (200 microM), 1.0 μl of SAD1R primer (200 microM), 2.0 μl of 10 mM each dNTP, 1 μl of Advantage 2 Polymerase Mix (Clontech), and water to a total volume of 50 μl. The reaction mixture was then subjected to the following thermocycling regimen: Step 1: 90° C., 4 min; Step 2: 94° C. , 30 sec; Step 3: 64° C. , 30 sec; Step 4: go to Step 2, 18 times or 25 times; Step 5: 68° C. , 2 min; Step 6: 14° C. , indefinite. After the amplification, the reaction was purified with AMPure beads (Agencourt). Eighty microliters of AMPure bead mix was added to the PCR reaction, and he beads were separated from the liquid in a magnetic particle capture unit, and the supernatant discarded. The beads were washed twice in 70% ethanol, followed by air drying. The amplified double stranded cDNA (dscDNA) library was eluted in 12 μl of 10 mM Tris-Cl pH 7.5.

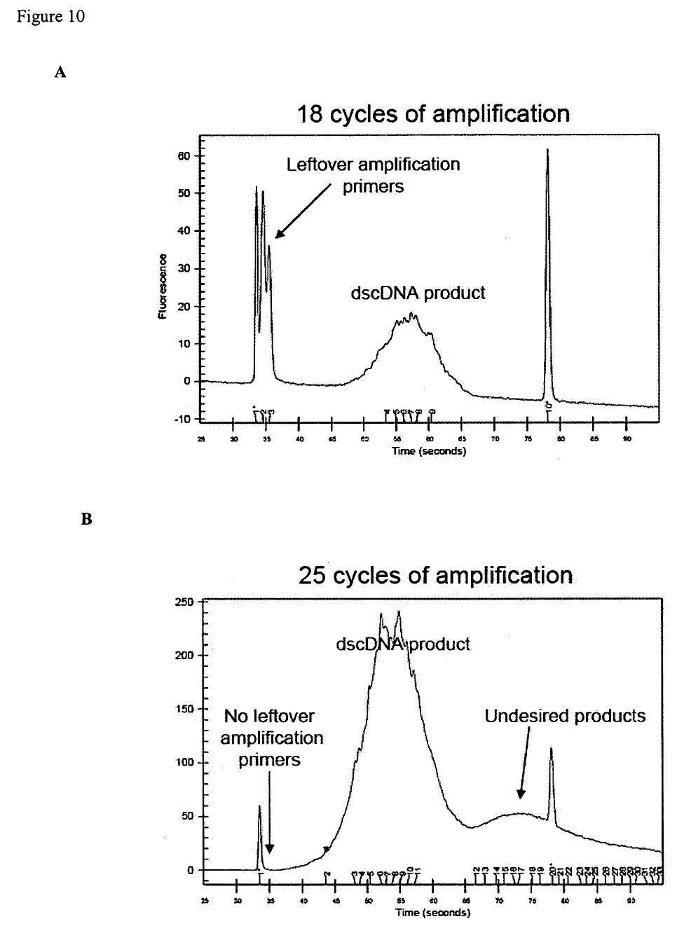

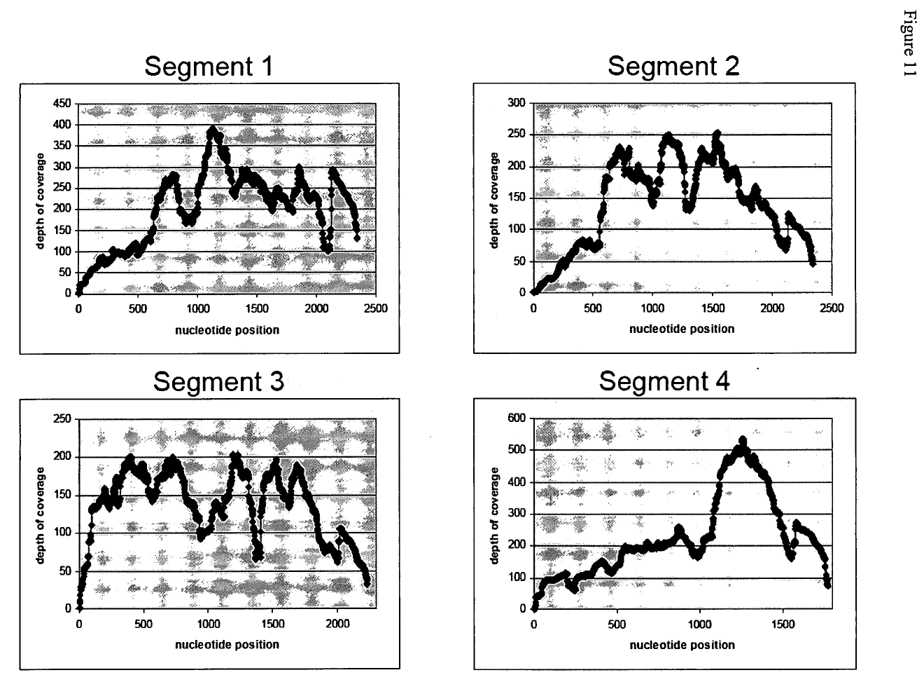

It was found that 18 cycles of amplification was favorable to 25 cycles of amplification, as after 25 cycles (but not after 18 cycles), undesired products, as well as a severe depletion of amplification primers, were observed (see FIG. 10 A and 10 B).

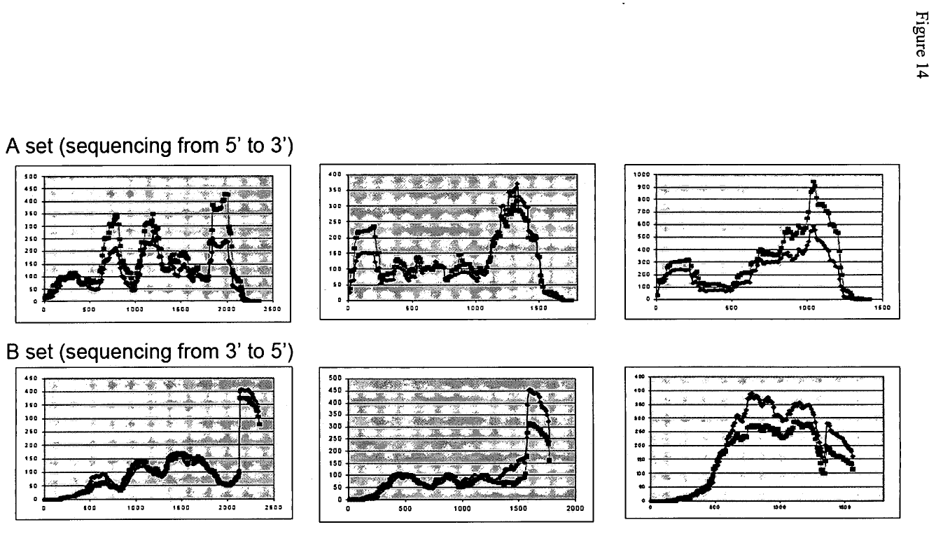

It was observed that the size distribution of dscDNA libraries obtained from 10, 20, 50, or 200 ng of starting viral RNA was highly similar (FIG. 13), demonstrating the surprising ability of the methods of the present invention to produce cDNA libraries from minute quantities of RNA.

The cDNA libraries thus obtained were then subjected to nucleotide sequencing by the sequencing technologies developed by 454 Life Sciences (Branford, CT). These technologies for direct sequencing of nucleic acids have been disclosed in co-pending U.S. patent application Ser. Nos. 10/767,779, 10/767,899, 10/768729, and 10/767,779, all filed Jan. 28, 2004, and U.S. Ser. No. 11/195,254, filed Aug. 1, 2005. Approximately 13600 High quality reads were obtained. Of these, 12820 (94.26%) found a BLAST hit of at least 35 nt in the known influenza strain A genome. The distribution of the 12820 BLAST hits among the 8 segments or the influenza virus strain A RNA genome are shown in Table 2.

TABLE 2
Number of high quality reads with BLAST hits, listed
by genome segment of influenza virus strain A.

| Segment hit | Number of BLAST hits |
|---|---|
| Segment 1 | 2529 |
| Segment 2 | 1709 |
| Segment 3 | 1616 |
| Segment 4 | 2054 |
| Segment 5 | 1424 |
| Segment 6 | 2087 |
| Segment 7 | 855 |
| Segment 8 | 546 |

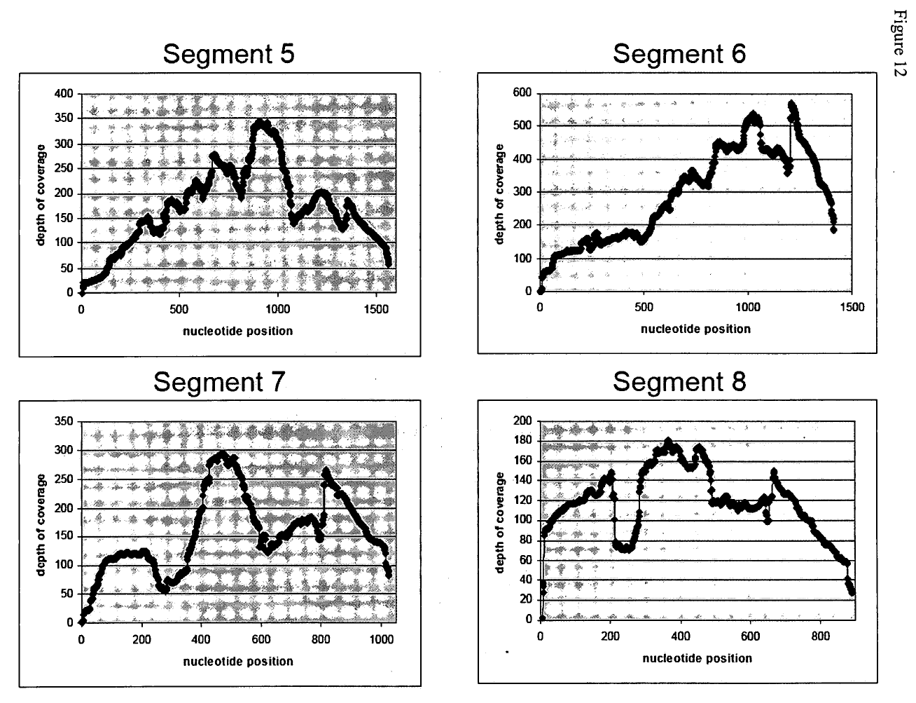

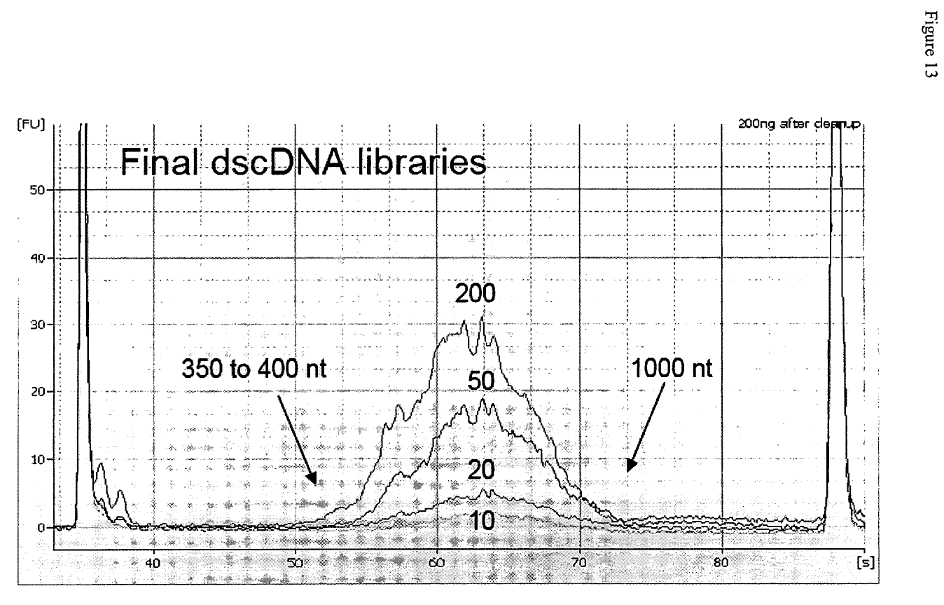

The depth of coverage across the eight segments of the influenza virus strain a RNA is depicted in FIGS. 11 and 12, which show that the methods of the present invention yielded coverage across each of the 8 segments.

In order to assess the performance of the methods of the present invention over different starting RNA amounts, the number of high quality reads, BLAST positive reads, and percentage of BLAST-positive high quality reads was compared The data showed that similar results were obtained with 10, 20, 50 or 200 ng of starting material, regardless of the sequencing direction (Table 3 and FIG. 14).

TABLE 3
Table 3: Sequencing results obtained from 10, 20, 50 or 200 ng of
starting RNA. Sequencing was performed from 5' to 3' (A; top 4 rows)
and from 3' to 5' (B; bottom 4 rows).

| Sample amount/ | | | |
|---|---|---|---|
| sequencing direction | HQ | BLAST >35 nt | % HQ BLAST >35 nt |
| 10 ng/A | 10303 | 8901 | 86.39 |
| 20 ng/A | 9760 | 8474 | 86.82 |
| 50 ng/A | 10318 | 9038 | 87.59 |
| 200 ng/A | 12992 | 11584 | 89.16 |
| 10 ng/B | 10655 | 9397 | 88.19 |
| 20 ng/B | 9338 | 8320 | 89.10 |
| 50 ng/B | 10908 | 9816 | 89.99 |
| 200 ng/B | 8401 | 7541 | 89.76 |

HQ: High Quality reads;
Blast >35 nt: HQ reads with a positive BLAST hit over 35 nucleotides to the known influenza virus strain A sequences.
% HQ BLAST >35nt: Percentage of HQ reads with a positive BLAST hit over 35 nucleotides to the known influenza virus strain A sequence. Part of this data is graphically represented in FIG. 14.

Other embodiments and uses of the invention will be apparent to those skilled in the art from consideration of the specification and practice of the invention disclosed herein. All patents, patent applications, and other references noted herein for whatever reason are specifically incorporated by reference. The specification and examples should be considered exemplary only with the true scope and spirit of the invention indicated by the following claims.

What is claimed is:

1. A method for generating a library from RNA comprising the steps of:
(a) fragmenting said RNA to produce fragmented RNAs;
(b) hybridizing a plurality of primers to said fragmented RNAs to form hybridized primers;
(c) elongating said hybridized primers with reverse transcriptase to form a plurality of single stranded cDNAs from said RNA, wherein said single stranded cDNAs comprises said plurality of primers at a 5′ end;
(d) ligating a first adaptor to said 5′ end of said cDNA, wherein said adaptor comprises an overhanging 5′ end region which is complementary to a 5′ end of said single stranded cDNA and ligating a second adaptor comprising an overhanging 3′ end region that is complementary to a 3′ end of said cDNA to form a single stranded cDNA comprising a first adaptor at a 5′ end and a second adaptor at a 3′ end
(e) purifying said single stranded cDNAs to generate said cDNA library.

2. The method of claim 1 wherein said fragmenting step produces fragmented RNAs of between 20 bases to 10 kb bases in size.

3. The method of claim 1 wherein said fragmenting step produces fragmented RNAs of between 100 bases to 1000 bases in size.

4. The method of claim 1 wherein said fragmenting step produces fragmented RNAs of between 150 bp to 500 bp in size.

5. The method of claim 1 further comprising the step of size selecting said fragmented RNAs after said fragmenting step.

6. The method of claim 4 wherein said size selecting enriches for RNA of a size of between 150 bp to 500 bp.

7. The method of claim 1 further comprising the step of digesting the fragmented RNAs with RNase between the elongating and the ligating steps.

8. The method of claim 1 wherein said plurality of primers are semi-random primers comprising one or more nonrandom primer bases of known identity.

9. The method of claim 8 wherein said first adaptor comprises a single stranded region and a double stranded region and wherein said single stranded region is a semi-random single stranded region comprising one or more nonrandom adaptor bases of known identity within a random sequence and wherein said nonrandom primer bases are complementary to said nonrandom adaptor bases.

10. The method of claim 8 wherein the plurality of primers comprise a sequence of xnnx and wherein the semi-random single stranded region of the first adaptor comprise a sequence of ynny, wherein x and y are complementary bases and wherein n is a random base.

11. The method of claim 10 wherein xnnx is tnnt and ynny is anna.

12. The method of claim 9 wherein the primer comprises the sequence of tnntnnnnnn (SEQ ID NO:1).

13. The method of claim 1 wherein said first adaptor or second adaptor further comprises one member of a binding pair.

14. The method of claim 13 wherein said binding pair is selected from the group consisting of FLAG/FLAG antibody; Biotin/avidin, biotin/streptavidin, receptor/ligand, antigen/antibody, receptor/ligand, polyHIS/nickel, protein A/antibody and derivatives thereof.

15. The method of claim 13 wherein said purifying step comprises purifying said single stranded cDNA by said one member of a binding pair.

16. The method of claim 1 wherein said purifying step is a size fractioning step.

17. The method of claim 1 wherein said method is performed in the absence of a DNA dependent DNA polymerase.

18. The method of claim 13 wherein said one member of a binding pair is biotin and wherein said purifying step is performed by binding said single stranded cDNA to a streptavidin coated solid support.

19. The method of claim 1 wherein said first adaptor comprises two strands of nucleic acid and wherein said one member of a binding pair attached to one of the strands.

20. The method of claim 1 wherein said second adaptor comprises two stands of nucleic acid and wherein said one member of a binding pair attached to one of the strands.

21. The method of claim 1 wherein said purifying step comprises denaturing said cDNA to remove any nucleic acid hybridized to said cDNA.

22. The method of claim 20 wherein said denaturing step denatures the first and second adaptors at the 5′ and 3′ end of said cDNAs.

23. The method of claim 1 further comprising the step of determining at least a partial nucleic acid sequence of said single stranded cDNAs.

24. The method of claim 1 further comprising the step of performing cDNA subtraction on said cDNA library.

25. The method of claim 1 wherein said RNA is from a single tissue.

26. The method of claim 1 wherein said RNA is from a source selected from the group consisting of: multiple tissues, single cell, plurality of cells, bodily fluids, single organism, plurality of organisms, environmental sample, biofilm, bacteria, archae, fungus, plants, animal, human, virus, retrovirus, phage, parasite, tumor, tumor sample, or biological specimen.

27. The method of claim 1 wherein said RNA is from cells at the same cell cycle.

28. An unamplified single stranded cDNA library produced by the method of claim 1.

29. A subtracted cDNA library produced by the method of claim 28.

30. A method for generating a library from RNA comprising the steps of:
(a) fragmenting said RNA to produce fragmented RNAs;
(b) hybridizing a plurality of primers to said fragmented RNAs to form hybridized primers wherein said primers comprise a 5′ region with an adaptor sequence and a 3′ region for hybridizing to said fragmented RNA;
(c) elongating said hybridized primers with reverse transcriptase to form a plurality of single stranded cDNAs from said RNA, wherein said single stranded cDNAs comprises said plurality of primers at a 5′ end;
(d) ligating an adaptor comprising an overhanging 3′ end region that is complementary to a 3′ end of said cDNA to form a single stranded cDNA comprising an adaptor at a 3′ end
(e) purifying said single stranded cDNAs to generate said cDNA library.

31. The method of claim 30 wherein said 3′ region of said primers comprise a sequence of nnnnnn.

32. The method of claim 30 wherein said 3′ region of said primers comprise a sequence of nnnnnnv.

33. The method of claim 30 wherein said 3′ region of said primers comprise a sequence of ttttttv.

34. The method of claim 30 wherein said fragmenting step produces fragmented RNAs of between 20 bases to 10 kb bases in size.

35. The method of claim 30 wherein said fragmenting step produces fragmented RNAs of between 100 bases to 1000 bases in size.

36. The method of claim 30 wherein said fragmenting step produces fragmented RNAs of between 150 bp to 500 bp in size.

37. The method of claim 30 further comprising the step of size selecting said fragmented RNAs after said fragmenting step.

38. The method of claim 37 wherein said size selecting enriches for RNA of a size of between 150 bp to500 bp.

39. The method of claim 30 wherein said RNA is a population of RNA enriched for polyA RNAs.

40. The method of claim 30 further comprising the step of digesting the fragmented RNAs with RNase between the elongating and the ligating steps.

41. The method of claim 1 wherein said primers or said adaptor further comprises one member of a binding pair.

42. The method of claim 40 wherein said binding pair is selected from the group consisting of FLAG/FLAG antibody; Biotin/avidin, biotin/streptavidin, receptor/ligand, antigen/antibody, receptor/ligand, polyHIS/nickel, protein A/antibody and derivatives thereof.

43. The method of claim 42 wherein said purifying step comprise purifying said single stranded cDNA by said one member of a binding pair.

44. The method of claim 30 wherein said purifying step is a size fractioning step.

45. The method of claim 30 wherein said method is performed in the absence of a DNA dependent DNA polymerase.

46. The method of claim 43 wherein said one member of a binding pair is biotin and wherein said purifying step is performed by binding said single stranded cDNA to a streptavidin coated solid support.

47. The method of claim 30 wherein said adaptor comprises two stands of nucleic acid and wherein said one member of a binding pair is attached to one of the strands.

48. The method of claim 30 wherein said purifying step comprises denaturing said cDNA to remove any nucleic acid hybridized to said cDNA.

49. The method of claim 30 wherein said denaturing step denatures the adaptor at the 3′ end of said cDNAs.

50. The method of claim 30 further comprising the step of determining at least a partial nucleic acid sequence of said single stranded cDNAs.

51. The method of claim 30 further comprising the step of performing cDNA subtraction on said cDNA library.

52. The method of claim 30 wherein said RNA is from a single tissue.

53. The method of claim 30 wherein said RNA is from a source selected from the group consisting of: multiple tissues, single cell, plurality of cells, bodily fluids, single organism, plurality of organisms, environmental sample, biofilm, bacteria, archae, fungus, plants, animal, human, virus, retrovirus, phage, parasite, tumor, tumor sample, or biological specimen.

54. The method of claim 30 wherein said RNA is from cells at the same cell cycle.

55. An unamplified single stranded cDNA library produced by the method of claim 30.

56. A subtracted cDNA library produced by the method of claim 55.


SEQUENCE LISTING (6 sequences)

SEQ ID NO: 1 - DNA, 9 bp, Artificial Sequence
  Description of Artificial Sequence Synthetic oligonucleotide
ttttttttv

SEQ ID NO: 2 - DNA, 10 bp, Artificial Sequence
  Description of Artificial Sequence Synthetic oligonucleotide
  modified_base (10): a, t, c, g
ttttttttvn

SEQ ID NO: 3 - DNA, 19 bp, Artificial Sequence
  Description of Artificial Sequence Synthetic oligonucleotide
gcctccctcgcgccatcag

SEQ ID NO: 4 - DNA, 23 bp, Artificial Sequence
  Description of Artificial Sequence Synthetic oligonucleotide
  modified_base (1): a, t, c, g
  modified_base (3)..(4): a, t, c, g
nannactgatggcgcgagggagg

SEQ ID NO: 5 - DNA, 25 bp, Artificial Sequence
  Description of Artificial Sequence Synthetic oligonucleotide
  modified_base (20)..(25): a, t, c, g
gccttgccagcccgctcagnnnnnn

SEQ ID NO: 6 - DNA, 18 bp, Artificial Sequence
  Description of Artificial Sequence Synthetic oligonucleotide
ctgagcgggctggcaagg